(19) United States
(12) Patent Application Publication
(10) Pub. No.: US 2026/0212395 A1
(43) Pub. Date: Jul. 23, 2026

(54) METHOD AND SYSTEM FOR USER-SPECIFIC ORAL HEALTH CARE PRODUCT SELECTION

(71) Applicant: KONINKLIJKE PHILIPS N.V., EINDHOVEN (NL)

(72) Inventor: Daniel Philip FARLEY, Bothell, WA (US)

(21) Appl. No.: 19/142,196

(22) PCT Filed: Dec. 20, 2023
(86) PCT No.: PCT/EP2023/086889

§ 371 Date: Jun. 21, 2025

Related U.S. Application Data
(60) Provisional application No. 63/434,542, filed on Dec. 22, 2022.

(51) Int. Cl. A61C 9/00; A61C 17/22; A61C 19/06; G06Q 30/0601

(52) U.S. Cl. CPC A61C 9/0066; G06Q 30/0624; A61C 17/228; A61C 19/066

(57) ABSTRACT

Methods and systems for selecting a user-specific oral health care product are disclosed. An exemplary method includes obtaining a parameterized statistical shape model database of dental anatomy from subjects representing a population of interest, measuring landmark data of dental anatomy of a user, processing data of the parameterized statistical shape model and the measured landmark data to generate an estimated user-specific dentition model, and selecting an oral health care product from a plurality of oral health care products based on information retrieved from the estimated user-specific dentition model and predetermined parameters of the oral health care product.

### FIELD OF THE INVENTION

The present disclosure relates to non-invasive systems and methods for selecting a user-specific oral health care product.

### BACKGROUND

Measurement of dental anatomy can be a key input for dental professionals when making treatment decisions or sizing oral health products. Historically, dental professionals create a negative imprint of a subject's dental anatomy by inserting a tray of soft, curable plaster into the mouth of the patient and then utilizing the cured impression material as a cast to create a custom dental model. More recently, three-dimensional scanning technology has been adopted to generate anatomical representations. There are various intraoral scanning technology products on the market; however, these are expensive pieces of equipment and require operation by a trained professional.

### SUMMARY

There is a persisting need for improved measuring and modelling techniques of dentition of a patient to provide better dental health. Addressing a need for improvements in oral health care technology, systems and methods are provided for selecting a user-specific oral health care product.

The inventive subject matter is directed to a method for selecting a user-specific oral health care product including the steps of obtaining a parameterized statistical shape model database of dental anatomy from subjects representing a population of interest, measuring landmark data of dental anatomy of a user, processing data of the parameterized statistical shape model and the measured landmark data to generate an estimated user-specific dentition model, and selecting an oral health care product from a plurality of oral health care products based on information retrieved from the user-specific dentition model and one or more predetermined parameters of the oral health care product.

In some embodiments, the landmark data of dental anatomy of the user are measured with a non-invasive imaging device, for example a depth-sensing device, such as a device selected from the group consisting of a time-of-flight depth sensor, a structured light transmitter and detector, a stereo-depth camera, or a light detection and ranging (LiDAR) sensor. In other embodiments, the non-invasive imaging device includes a two-dimensional measuring application and manual identification of landmarks of dental anatomy of the user. In some embodiments, the landmark data include data of dental landmarks from a front of a mouth of the user. In some embodiments, the landmark data include data of landmarks present on teeth selected from the group consisting of a right central incisor, a left central incisor, a right lateral incisor, a left lateral incisor, a right cuspid, a left cuspid, a right first bicuspid, and a left first bicuspid. In other embodiments, the landmark data include data of a jaw length of the user. In some embodiments, the measuring of landmark data of dental anatomy of the user includes taking a depth image from the user's exposed teeth and/or at least one jaw. In some embodiments, the measuring of landmark data of dental anatomy of the user includes taking a depth image with a smartphone depth camera. In some embodiments, the oral health care product includes a mouthpiece toothbrush head. In other embodiments, the oral health care product includes a tooth whitening tray.

According to an example implementation of the inventive subject matter, a system for selecting a user-specific oral health care product includes a dental scan database containing a parameterized statistical shape model of dental anatomy from subjects representing a population of interest, a non-invasive imaging device adapted to measure landmark data of dental anatomy of a user, a processing system in communication with the dental scan database and the non-invasive depth-sensing device, the processing system configured to apply the measured landmark data to the statistical shape model to generate an estimated user-specific dentition model, a product database containing parameterized data of a plurality of oral health care products, and wherein the processing system is configured to select an oral health care product from a plurality of oral health care products based on the estimated user-specific dentition model and one or more predetermined parameters of the oral health care product.

In some embodiments, the imaging device includes a depth-sensing device. For example, a device selected from the group consisting of a time-of-flight depth sensor, a structured light transmitter and detector, a stereo-depth camera, or a light detection and ranging (LiDAR) sensor. In some embodiments, the processing system is implemented on a smartphone. In some embodiments, the one or more predetermined parameters of the oral health care product include a geometry of the oral health care product. In some embodiments, the processing system includes a user interface to communicate the selected oral health care product to the user.

According to another implementation, a method for selecting a user-specific oral health care product includes obtaining a parameterized statistical shape model database of dental anatomy from subjects representing a population of interest, scanning a dental impression of dental anatomy of a user, processing data of the parameterized statistical shape model and the scanned dental impression to generate an estimated user-specific dentition model, and selecting an oral health care product from a plurality of oral health care products based on information retrieved from the estimated user-specific dentition model and one or more predetermined parameters of the oral health care product.

According to another implementation, a method for selecting a user-specific oral health care product includes scanning dental anatomy of a user to generate a user-specific dentition model, and selecting an oral health care product from a plurality of oral health care products based on information retrieved from the user-specific dentition model and one or more predetermined parameters of the oral health care product.

The inventive subject matter overcomes challenges associated with providing accurate sizing of applicable oral health care products in a non-clinical environment. Measurement of human dental anatomy can be invasive, time-consuming, and require the presence of a dental professional. The inventive subject matter supplants the need for anatomical characterization by a dental professional, which is often accomplished by creation of dental impressions, and more recently use of expensive oral scanning technologies.

Knowledge of a subject's dental anatomy can be used to select an appropriate size of dental implants, but could also be used to suggest sizes and/or shapes of various personal oral health care products. For example, such information can be useful at a point of sale to suggest a certain size and/or shape of a power toothbrush brush head. This can be of particular benefit for users purchasing mouthpiece-type products, such as full mouth toothbrushes, half-mouth toothbrushes, or whitening mouthpieces, where a large contact area between dentition and device requires more exact matching of the shape of the product and size of the product.

The inventive subject matter allows consumers purchasing oral health care products to select a product that achieves the best fit and performance from their purchase. The inventive subject matter allows creation of more targeted and effective products, especially those that require an intimate fit with a large portion of a user's dentition, such as in a mouthpiece toothbrush or mouthpiece whitening tray. By selecting a product based on an estimated user-specific dentition model, treatment options can be tailored to the specific characteristics of the user's anatomy and, thereby, improve the overall effectiveness of oral health care product.

These and other aspects of the disclosure will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the inventive subject matter.

FIG. 1 is a high-level flowchart of an exemplary method for selecting a user-specific oral health care product.

FIG. 2 is a top view of a maxillary dental arch wherein dental landmarks visible for imaging or depth imaging from the front of the mouth are indicated by reference points relative to an x-axis and a y-axis as used in an exemplary method.

FIG. 3 shows a side view of the maxillary dental arch wherein dental landmarks visible for imaging or depth imaging from the front of the mouth are indicated by reference points relative to a y-axis and a z-axis as used in an exemplary method.

FIG. 4 is a schematic diagram showing components of an exemplary system for selecting a user-specific oral health care product.

FIG. 5 is a high-level flowchart of a workflow of an exemplary system for selecting a user-specific oral health care product.

FIG. 6 is a high-level flowchart of an exemplary workflow for product size selection by using a smartphone measuring app.

### DETAILED DESCRIPTION OF EMBODIMENTS

This disclosure relates to methods and systems that can be utilized to quickly and non-invasively create a three-dimensional model of a user's dental anatomy. Implementations of the inventive subject matter rely on a parameterized statistical shape model and landmark detection of a key feature or set of features. In some embodiments, a statistical shape model of the teeth and/or jaws is applied to estimate the three-dimensional shape of a particular dentition, for example by measuring the location of only a few landmarks or tooth surfaces with a smartphone. As discussed below, statistical shape models of the mouth can be created using mathematical techniques such as principal component analysis. In some embodiments, tooth and/or jaw measurements can be accomplished by measuring key dental landmarks in the front of the mouth using a calibrated depth camera. The inventive subject matter can be optimized for implementation on a mobile phone.

As used herein, the term “user-specific oral health care product” refers to one or more products, devices, apparatuses, instruments, or equipment, that are used for care of the teeth, gums, tongue, mouth, and/or any parts of or the entire oral-facial anatomy. Examples of user-specific oral healthcare products may include toothbrushes, tooth-whitening products, dental implants, dentures, and related devices. In some embodiments, the range of oral healthcare products can be two or more sizing options and/or selecting the best fit between two or more options. In other embodiments, a user-specific healthcare product can include custom devices.

As used herein, the term “non-invasive” refers to systems, method, and/or components that do not require a care-provider input, or do not involve additional equipment or tools to be inserted into the oral cavity.

As used herein, the term “dental anatomy” can refer to a tooth, a jaw, a gum, a lingual tooth surface, a subgingival surface, an interproximal gap, or any other anatomical feature of interest, or combinations thereof.

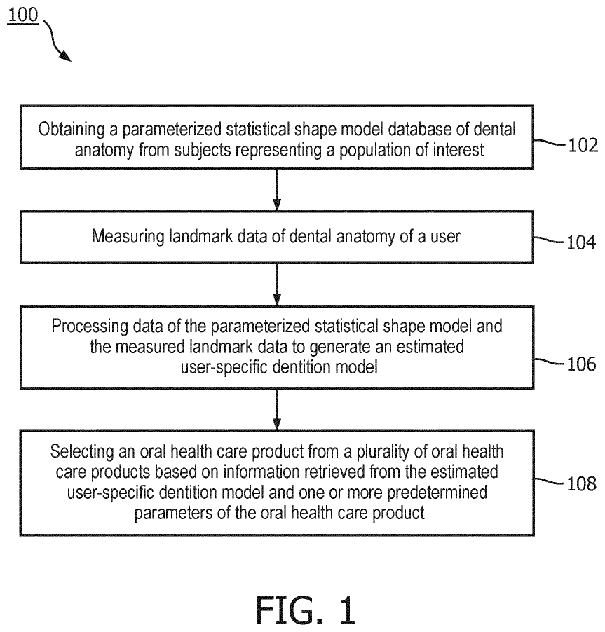

FIG. 1 is a flowchart illustrating the steps of a method 100 for selecting a user-specific oral health care product according to the inventive subject matter. In step 102, a parameterized statistical shape model database is obtained of dental anatomy from subjects representing a population of interest. In step 104, landmark data of dental anatomy of a user are measured with a non-invasive depth-sensing device. In step 106, data of the parameterized statistical shape model and the measured landmark data are processed to generate an estimated user-specific dentition model. In step 108, an oral health care product is selected from a plurality of oral health care products based on information retrieved form the estimated user-specific dentition model and one or more predetermined parameters of the oral health care product.

It should be appreciated that the order of steps shown in FIG. 1 is exemplary, and the steps may be performed in other orders or combinations. Method 100 can use the systems, arrangements, and components of any of the embodiments described herein.

In one example embodiment, the parameterized statistical shape model can be a parameterized statistical shape model of human jaws and/or teeth and the depth sensing device can be smartphone depth camera to collect spatial landmark data. These two components can be used in conjunction to determine a statistically likely representation of a user's dental anatomy, which can be in turn used to suggest a particular sized product, such as a mouthpiece-style toothbrush head. However, there can be many other variations, modifications, and alternatives. Additional features and details of the components and steps according to the inventive subject matter will be described below with reference to example embodiments.

### Statistical Shape Model

In general, a statistical shape atlas combines information from multiple subjects into one unified representation and serves as a three-dimensional medical image analysis tool that encodes shape variations between populations. For medical images, the general shape, location, and orientation of an anatomical structure is known, and this knowledge may be incorporated into a deformable model in the form of initial conditions, data constraints, and constraints on the model shape parameters, or into the model fitting procedure.

According to the disclosure, a statistical shape model can be created to represent anatomy of a population of interest. To build such a statistical shape model, a particular shape representation can be selected. For example, a statistical shape model can be constructed from three-dimensional scans of dental impressions from many subjects which represent the consumer population of interest for a particular oral health care product.

In some embodiments, the captured three-dimensional scans can serve as training sets and can be configured in a mesh format, decimated, and consistently aligned using any alignment techniques, such as iterative closest point analysis or Procrustes alignment to analyze the distribution of a set of shapes. Once aligned the main shape modes can be calculated using principal component analysis (PCA), as demonstrated by Wu, et al., Construction of statistical shape atlases for bone structures based on a two-level framework, Int J Med Robotics Comput Assist Surg 2010; 6:1-17, the entire disclosure of which is hereby incorporated by reference herein.

In the example embodiment, the mean shape of the jaw can be calculated. Since PCA is a dimensionality reduction technique, each jaw in the database is represented by a mean jaw shape x̅_{jaw} and a linear combination of scaled principal component vectors, as represented in the equation below, where X₁ is the coefficient for a particular principal component PC₁. Often, the majority of variation can be captured in only a few principal components, for example 10 or 12 principal components.

$${Jaw}_{x} = {\overline{x}}_{jaw} + {X}_{1} {PC}_{1} + {X}_{2} {PC}_{2} + {X}_{3} {PC}_{3} … {X}_{n} {PC}_{n}$$

The statistical shape model allows for the creation of new anatomies that are not in the training data set. One can see that altering the coefficient values X in the equation above would create a series of new shapes which are plausible combinations of features from the training dental anatomies. This way, with knowledge of a sparse representation of a user's true dental anatomy, such as provided by data of landmark locations, the statistical shape model can be iteratively morphed, i.e., changing coefficients, until a sufficient fit is achieved.

As used herein, the term “parameterized statistical shape model” refers to the process of defining a correspondence between values of one or more parameters and positions or dimensions on the resulting shape so that a given value of the parameter defines a set of unique locations on the shape. For example, in the statistical shape model of a jaw described above, landmark locations could serve as morphing targets to change the mean shape of the jaw into an estimated user-specific dentition model.

### Landmark Detection

In imaging, landmarks are being used to extract regions of interest or assist in model fitting. Landmark detection can be accomplished by using a two-dimensional or three-dimensional imaging device as discussed below with reference to example embodiments.

In some embodiments, the imaging device may include sensors to obtain depth images. Depth imaging technologies are pervasive in the mobile phone industry and are convenient for a user. Commonly, these technologies are used for biometric identification, for example to unlock a mobile phone and/or mobile phone application with a face scan. Suitable and inexpensive depth imaging devices that are suitable for use in the disclosed system include a time-of-flight depth sensor, a structured light transmitter and detector, a stereo-depth camera, or a light detection and ranging (LiDAR) sensor.

For successful execution of anatomy characterization, a set of appropriately scaled landmark locations is required. In some embodiments, a user can take a depth image of their exposed teeth and jaws with the smartphone camera. The output of this activity can be a dense point cloud of the user's exposed dental anatomy.

In some embodiments, point cloud data can be used for landmark identification/localization. Examples include surface wrapping, such as convex hull technique or equivalent. See for example, O'Sullivan, et al., Extending Convolutional Pose Machines for Facial Landmark Localization in 3D Point Clouds, Conference: 2019 IEEE/CVF International Conference on Computer Vision Workshop, the entire disclosure of which is hereby incorporated by reference herein.

In some embodiments, smartphone images may include depth meta data, as with iPhone® images for example, so there can be correspondence between depth image data and RBG image data, and thus, landmark identification can be done on a two-dimensional photo and translated into a three-dimensional depth image. In one example embodiment, a user can capture a depth image of their teeth using a smartphone depth camera, such as an iPhone® TrueDepth® camera from Apple®. Key dental landmarks identified from the depth image can be used to morph the statistical shape model to match the shape of the user's dentition and/or jaw. The resulting model can be analyzed for sizing of a mouthpiece by one of several classification techniques. In other embodiments, the landmark data can include data of landmarks of at least a portion of the face, for example dimensions of a jaw.

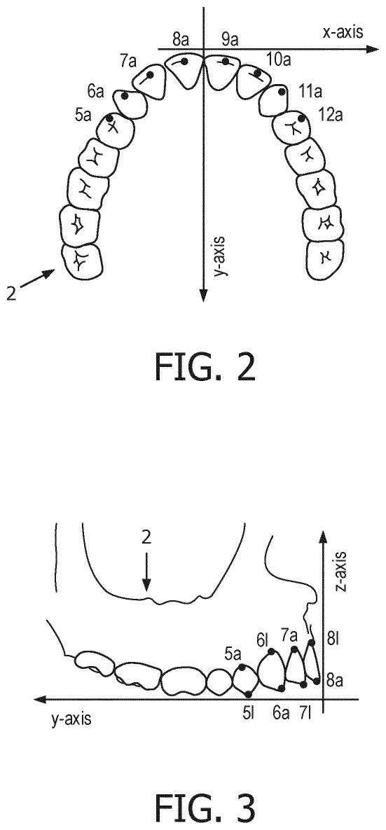

FIGS. 2-3 illustrate landmark detection according to the disclosure by using dental landmarks visible for imaging or depth imaging from the front of the mouth. In FIG. 2, landmarks are marked on a top view of a maxillary dental arch 2 and are indicated by reference points relative to an x-axis and a y-axis. In FIG. 3, landmarks are marked on a side view of the maxillary dental arch 2 and are indicated relative to an x-axis and a z-axis. Landmarks on the side view are mirrored on the other side of the mouth. Landmarks shown for the upper (maxillary) portion of the jaws can be mirrored for the bottom (mandibular) portion of the jaws. Landmarks shown on the side view can be mirrored on the other side of the mouth. Landmark data would not be collected for missing teeth or for teeth that are not visible. Landmark points and their descriptions corresponding to those identified in FIGS. 2-3 are described in Table 1 below.

TABLE 1

| | Type of | |
|---|---|---|
| ID | Measurement | Description |
| 5a | Point (x-y-z) | Cusp of maxillar right 1^{st} bi-cuspid (if visible) |
| 5l | Point (x-y-z) | Facial sulces of maxillar right 1^{st} bi-cuspid if |
| | | visible |
| 6a | Point (x-y-z) | Cusp of maxillar right cuspid |
| 6l | Point (x-y-z) | Facial sulces of maxillar right cuspid |
| 7a | Point (x-y-z) | Top centre of maxillar right lateral incisor |
| 7l | Point (x-y-z) | Facial sulces of maxillar right lateral incisor |
| 8a | Point (x-y-z) | Top centre of maxillar right central incisor |
| 8l | Point (x-y-z) | Facial sulces of maxillar right central incisor |
| 9a | Point (x-y-z) | Top centre of maxillar left central incisor |
| 9l | Point (x-y-z) | Facial sulces of maxillar left central incisor |
| 10a | Point (x-y-z) | Top centre of maxillar left lateral incisor |
| 10l | Point (x-y-z) | Facial sulces of maxillar left lateral incisor |
| 11a | Point (x-y-z) | Cusp of maxillar left cuspid |
| 11l | Point (x-y-z) | Facial sulces of maxillar left cuspid |
| 12a | Point (x-y-z) | Cusp of maxillar left 1st bi-cuspid (if visible) |
| 12l | Point (x-y-z) | Facial sulces of maxillar left 1st bi-cuspid if |
| | | visible |

It has been demonstrated that accurate three-dimensional representations of bony anatomy can be reconstructed from sparse image data and/or landmark data using PCA-derived statistical shape models. See for example Wang et al., Automatic construction of statistical shape models using deformable simplex meshes with vector field convolution energy, Wang and Shi BioMed Eng OnLine (2017) 16:49; Suwarganda et al., Minimal medical imaging can accurately reconstruct geometric bone models for musculoskeletal models, PLoS One. 2019; 14(2):e0205628; and Zhang et al., Accuracy of femur reconstruction from sparse geometric data using a statistical shape model, Computer Methods in Biomechanics and Biomedical Engineering (2017), 20:5, 566-576; the entire disclosures of which are incorporated herein by reference. Similarly, facial reconstruction has been achieved using morphable parametric models with spatial landmarks as input. See Wood et al., 3D Face Reconstruction with Dense Landmarks, Computer Vision—ECCV 2022, 17th European Conference, Tel Aviv, Israel, Oct. 23-27, 2022, Proceedings, Part XIII (pp. 160-177; the entire disclosure of which is incorporated herein by reference.

In some embodiments, an estimated user-specific dentition model can be created by using one of the disclosed techniques, or suitable alternatives, providing an accurate three-dimensional reconstruction of the user's mouth. In some embodiments, the estimated user-specific dentition model can be created in near-real time using a smartphone camera.

In further embodiments, instead of using sparse landmark data, data obtained by three-dimensional scanning, an entire point cloud of a scanned area can be used to create a three-dimensional user-specific dentition model. For example, a scanner can generate a three-dimensional surface of the exposed teeth and surface matching techniques can be used to morph or fit the statistical shape model.

### Size Selection

The estimated user-specific dentition model described above can then be used to extract key measurements that correspond to particular sized products. In some embodiments, where a selection is to be made of a plurality of mouthpiece toothbrushes having different sizes, a jaw length can be a predetermined parameter that determines proper device fit of the mouthpiece toothbrush. The jaw length can be extracted from the estimated user-specific dentition model. By selecting a properly sized mouthpiece toothbrush, the mouthpiece toothbrush provides the most suitable fit for the user and improves the overall effectiveness of the mouthpiece toothbrush.

### System Implementation

It is to be understood that embodiments of the disclosure can be implemented in various forms of hardware, software, firmware, special purpose processes, or a combination thereof. In one embodiment, the inventive subject matter can be implemented in software as an application program tangible embodied on a computer readable program storage device. The application program can be uploaded to, and executed by, for example a smartphone having any suitable architecture.

It is to be further understood that, because some of the constituent system components and method steps depicted in the accompanying figures can be implemented in software, the actual connections between the systems components or the process steps may differ depending upon the manner in which the inventive subject matter is programmed. Given the teachings of the disclosure provided herein, one of ordinary skill in the related art will be able to contemplate these and similar implementations or configurations of the inventive subject matter.

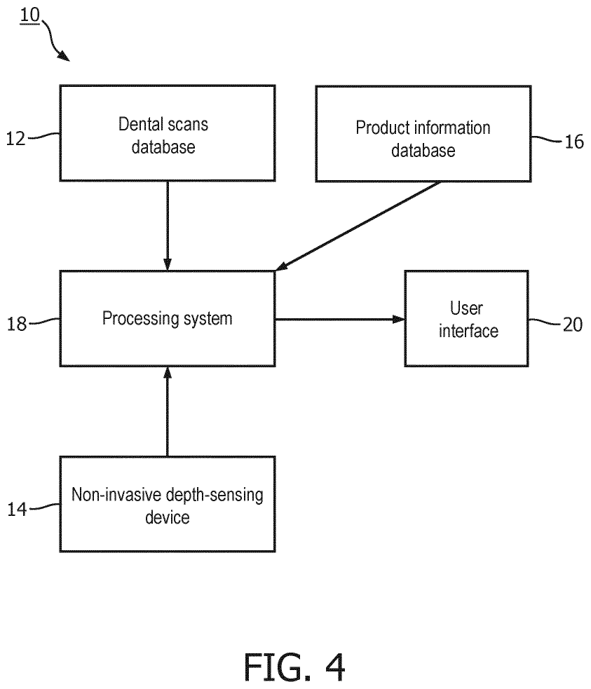

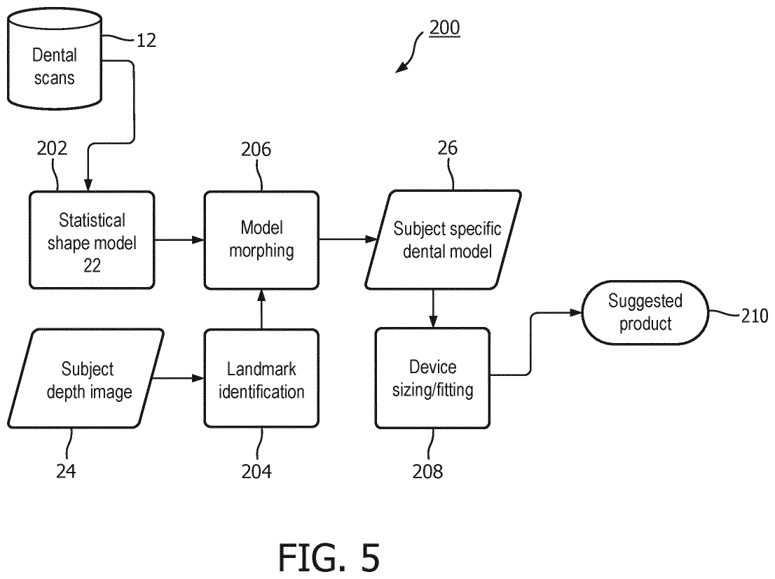

FIGS. 4-5 illustrate the workflow and components of an exemplary system 10 for selecting a user-specific oral health care product based on a subject depth image and predetermined product sizes. System 10 may include a central processing unit, a memory, and an input/output interface. System 10 can include or be coupled to an interface such as a display and/or various input devices, such as a keyboard or touchpad, or be voice-activated. Memory can include random access memory (RAM), read only memory (ROM) and/or other persistent, auxiliary, or non-transitory computer readable media or combinations thereof. The various processes and functions described herein can either be part of an application program which is executed via an operating system.

As illustrated in FIG. 4, components of system 10 may include a dental scans database 12, a non-invasive depth-sensing device 14, a product information database 16, a processing system 18, and a user interface 20. Processing system is operatively coupled to dental scans database 12, non-invasive depth-sensing device 14, and product information database 16. Dental scans database 12 includes a library of digital images of three-dimensional dentition models, such as dental scans from subjects representing a population of interest. Non-invasive depth-sensing device 14 is adapted to measure landmark data of dental anatomy of a user and communicate the measured landmark data to processing system 18.

Processing system 18 is configured to apply the measured landmark data to a statistical shape model to generate an estimated user-specific dentition model. Processing system 18 is further configured to select an oral health care product from a plurality of oral health care products based on the estimated user-specific model of dentition and one or more predetermined parameters of the oral health care product. The recommended oral health care product can be communicated to the user via a user interface 20.

As used herein, the term “processing system” refers to systems, method, and/or components that can be implemented in numerous ways to perform various functions discussed herein. Such functions may be implemented by dedicated hardware and a processor which may employ one or more microprocessors that may be programmed using software code. The term “processing system” may encompass a personal computer, a tablet computer, a smart phone, a microcontroller, a microprocessor, or any other digital processing engine, device or equivalent capable of executing software code including related memory devices, transmission devices, input/output devices, displays and equivalents. The software may cause the processing system to carry out one or more processes or one or more steps of one or more processes described or illustrated herein. Carrying out such processes or steps may include defining data structures stored in memory and modifying the data structures as directed by the software.

In some implementations, the dental scans database and the product information database may be encoded with one or more programs that, when executed on one or more processors and/or controllers, perform at least some of the functions discussed herein. Various databases may be fixed within a processor or controller or may be transportable, such that the one or more programs stored thereon can be loaded into a processor or controller so as to implement various aspects and functionalities of the present disclosure. In some embodiments, components of system 10 can transmit data via a Bluetooth transmitter, a Wi-Fi transmitter, a cellular transmitter, a wired transmitter, an optical transmitter, or any combination thereof.

FIG. 5 illustrates a workflow process 200 between select components of system 10 and depicts some of the steps encountered during operation of system 10. Although the flowchart may describe the operations as a sequential process, some of the operations may be performed in parallel or concurrently. The workflow process ends when a product is suggested to the user, but in some embodiments additional components or steps may be added that are not included in the figure.

The workflow process 200 starts with retrieving a dental scans from a collection of dental scans of subjects representing a population of interest stored in dental scans database 12. In step 202, a statistical shape model 22 is derived from the stored dental scans.

Workflow process 200 also receives input of data of subject depth image 24, derived from non-invasive depth-sensing device 14, for example as described above with a device adapted to measure landmark data of dental anatomy of a user. In step 204, landmark data are identified from subject depth image 24.

In step 206, the identified landmark date are morphed with the statistical shape model, for example as described above, into a user-specific dentition model 26 that represents an estimated three-dimensional shape of the dentition of the user.

In step 208, product information organized by different sizes and/or fittings of a plurality of oral health care products is retrieved from product information database 16 by processing system 18. The parameterized product information is compared with data of the estimated user-specific dentition model to determine which oral health care product would provide an optimal fit for the user.

Product information database 16 includes product information representing different oral health care products organized according to predetermined criteria. Product information database 16 may include a classification of the oral health care products based on one or more predetermined parameters of the oral health care product. Examples of such predetermined parameters may include a range of product sizes for mouthpiece toothbrushes or different types of fittings for tooth whitening trays.

In some embodiments, a mouthpiece toothbrush providing a proper fit to the user can be selected from the range based on the estimated user-specific dentition model and suggested to the user based on the jaw length extracted from the user-specific dentition model. In other embodiments, more than one user-specific oral health care product can be suggested. In further embodiments, the inventive subject matter can be applied to recommend a particular setting on an existing device. For example, a particular brushing intensity mode may be suggested on a power toothbrush device as being preferred for a specific user. In other embodiments, the disclosed method and system can be used to suggest a brightness intensity on a whitening device as being most effective for a specific user.

In other embodiments, predetermined parameters of the oral health care product can include one or a combination of jaw widths, for example a distal width at the molars or a mesial width at the canines. In further embodiments, predetermined parameters of the oral health care product can include a tooth width at specific regions, a tooth height, a jaw curvature, and/or tooth inclination.

In a final step 210, the result of the comparison is suggested to the user, for example via a user interface. The term “user interface” refers to an interface between a human user and one or more devices that enable communication between the user and the device(s). The selected product can be communicated to the user by visual means, auditory means, and/or by a more elaborate textual or graphic user interface, or other suitable means that enable communication between the user and the device(s). Examples of user interfaces that may be employed in various implementations of the present disclosure include, but are not limited to, display screens, various types of graphical user interfaces (GUIs), touch screens, microphones, and other suitable communication devices.

An advantage of the disclosed methods and systems is to provide a user-friendly, non-invasive means to achieve an apt selection from a range of dental products. When implemented in a mobile app, the inventive subject matter can be used at point-of-sale so consumers can correctly size the products as they buy them.

The implementation described above uses a three-dimensional reconstruction of the patient's dental anatomy; however, a similar product sizing strategy could be used taking two-dimensional measurements. In an example implementation, the method and system can use a two-dimensional sizing technique to select a user-specific oral health care product.

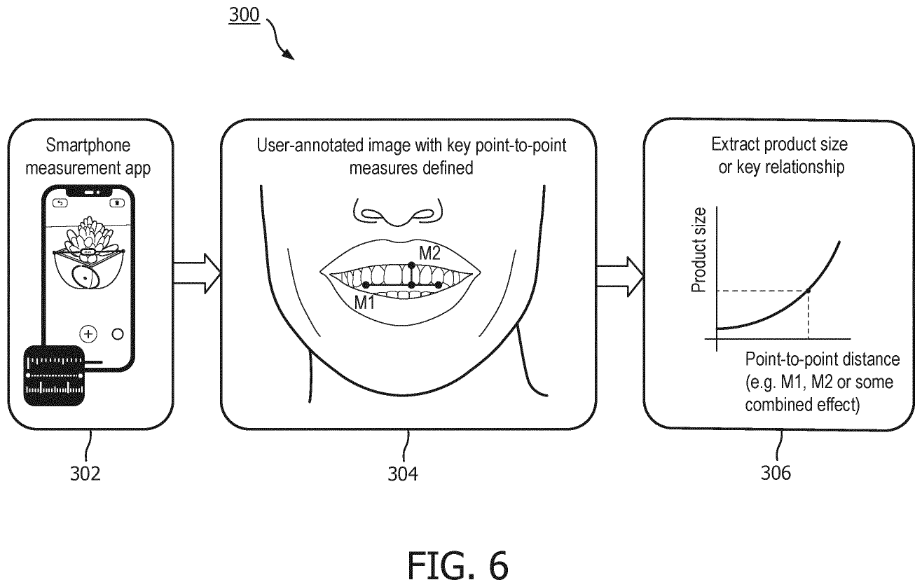

FIG. 6 illustrates a high-level workflow of an exemplary product sizing method 300 using an imaging device such as used with a smartphone measuring application. In step 302 of method 300, the user obtains a smartphone camera that has the capability to do real-time or retrospective point-to-point measurements, such as iPhones® with the Apple Measure app or Android® phones with the Google Measure app. This software is commercially available to most versions of mobile telephones. Other embodiments can use suitable augmented reality technology software that takes measurements and sends them directly to a remote computer for processing. By using the Measure app, for example, which uses augmented reality technology to turn a smartphone device into a tape measure, the size of objects can be gauged, the dimensions of rectangular objects can be automatically detected, and a photo of the measurement can be saved.

In step 304, the user can manually identify and/or place landmarks on a color photo of their dentition to obtain a user-annotated image with key point-to-point measures defined. With the Measure app, the user can measure one or more horizontal distances and/or one or more vertical distances. For example, as indicated in step 304 of FIG. 6, the user can measure a horizontal distance M1 between two horizontal landmark points and a vertical distance M2 between two vertical landmark points. The positions of these landmarks can be utilized as inputs for obtaining a digital data file of the user's dentition and morphing with a statistical shape model as described above.

Based on a relationship between a predetermined parameter of the oral health care product and a measured point-to-point distance, a particular product can be selected. For example, as illustrated in step 306, a relationship between a product size and distance M1, M2, or some combined effect can be used to select a particular size of a range of sizes of an oral health care product.

In another embodiment, the point-to-point measures can be utilized to determine a statistical relationship between point-to-point distances and jaw size and/or jaw shape, and suggested mouthpiece size. To achieve this, many jaws can be analyzed to determine which point-to-point distances and interactions between measures collected in situ are strongly correlated to key dental measurements that drive product sizing. This relationship may be determined through one of many regression techniques, and once established, can be used to directly select a particular sized product. An advantage of such an implementation is the simplicity and less computation required to characterize the anatomy and morph the statistical model.

In another implementation, the user may be provided with a means to create an impression of their teeth. For example, a bite registration tray, or full or partial dental impressions. In such an embodiment, the method includes the same steps as described above, but instead of directly scanning the teeth, the user-specific dentition model is generated by scanning a dental impression. The rest of the workflow remains the same. An advantage to this embodiment is that the user-specific dentition model can be morphed with a more robust representation of the user's dentition because data are available of a full jaw and not of just the front teeth. However, depending on the invasiveness of the impression collection strategy, it could require administration by a dental professional.

In another implementation, a method using scanning with a purpose-built imaging system can be used. Instead of using a smartphone depth camera and statistical shape model as described above, a user-specific dentition model can be created by using an intraoral scanner or equivalent. These systems are common in dental offices and can create high fidelity three-dimensional representation of the teeth and jaws.

In a further implementation, the system and method can be implemented by using at-home solutions for dental imaging, such as remote digital monitoring apps and devices. It is apparent that one of these devices can be used to generate depth images of the teeth and jaws with more access and repeatability than user-driven imaging techniques. Currently such devices are being used for patient monitoring and orthodontia.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” In addition, singular references do not exclude a plurality. Thus, references to “a”, “an”, “first”, “second” etc. do not preclude a plurality.

Reference signs in the claims are provided merely as a clarifying example shall not be construed as limiting the scope of the claims in any way.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method for selecting a user-specific oral health care product, the method comprising:
obtaining a parameterized statistical shape model database of dental anatomy from subjects representing a population of interest;
measuring landmark data of dental anatomy of a user;
processing data of the parameterized statistical shape model and the measured landmark data to generate an estimated user-specific dentition model; and
selecting an oral health care product from a plurality of oral health care products based on information retrieved from the estimated user-specific dentition model and one or more predetermined parameters of the oral health care product.

2. The method of claim 1, wherein the landmark data of dental anatomy of the user are measured with a non-invasive imaging device.

3. The method of claim 2, wherein the non-invasive imaging device includes a depth-sensing device.

4. The method of claim 3, wherein the depth-sensing device includes a device selected from the group consisting of a time-of-flight depth sensor, a structured light transmitter and detector, a stereo-depth camera, or a light detection and ranging (LiDAR) sensor.

5. The method of claim 2, wherein the non-invasive imaging device includes a two-dimensional measuring application and manual identification of landmarks of dental anatomy of the user.

6. The method of claim 1, wherein the landmark data include data of dental landmarks from a front of a mouth of the user.

7. The method of claim 1, wherein the landmark data include data of landmarks present on teeth selected from the group consisting of a right central incisor, a left central incisor, a right lateral incisor, a left lateral incisor, a right cuspid, a left cuspid, a right first bicuspid, and a left first bicuspid.

8. The method of claim 1, wherein the landmark data include data of a jaw length of the user.

9. The method of claim 1, wherein the measuring of landmark data of dental anatomy of the user includes taking a depth image from the user's exposed teeth and/or at least one jaw.

10. The method of claim 1, wherein the measuring of landmark data of dental anatomy of the user includes taking a depth image with a smartphone depth camera.

11. The method of claim 1, wherein the oral health care product includes a mouthpiece toothbrush head.

12. The method of claim 1, wherein the oral health care product includes a tooth whitening tray.

13. A system for selecting a user-specific oral health care product, the system comprising:
a dental scan database containing a parameterized statistical shape model of dental anatomy from subjects representing a population of interest;
an imaging device adapted to measure landmark data of dental anatomy of a user;
a processing system in communication with the dental scan database and the non-invasive depth-sensing device, the processing system configured to apply the measured landmark data to the statistical shape model to generate an estimated user-specific dentition model;
a product database containing parameterized data of a plurality of oral health care products; and
wherein the processing system is configured to select an oral health care product from a plurality of oral health care products based on the estimated user-specific dentition model and one or more predetermined parameters of the oral health care product.

14. The system of claim 13, wherein the imaging device includes a depth-sensing device.

15. The system of claim 14, wherein the depth-sensing device includes a device selected from the group consisting of a time-of-flight depth sensor, a structured light transmitter and detector, a stereo-depth camera, or a light detection and ranging (LiDAR) sensor.

16. The system of claim 13, wherein the processing system is implemented on a smartphone.

17. The system of claim 13, wherein the one or more predetermined parameters of the oral health care product include a geometry of the oral health care product.

18. The system of claim 13, wherein the processing system includes a user interface to communicate the selected oral health care product to the user.

19. A method for selecting a user-specific oral health care product, the method comprising:
obtaining a parameterized statistical shape model database of dental anatomy from subjects representing a population of interest;
scanning a dental impression of dental anatomy of a user;
processing data of the parameterized statistical shape model and the scanned dental impression to generate an estimated user-specific dentition model; and
selecting an oral health care product from a plurality of oral health care products based on information retrieved from the estimated user-specific dentition model and one or more predetermined parameters of the oral health care product.

20. A method for selecting a user-specific oral health care product, the method comprising:
scanning dental anatomy of a user to generate a user-specific dentition model; and
selecting an oral health care product from a plurality of oral health care products based on information retrieved from the user-specific dentition model and one or more predetermined parameters of the oral health care product.
